(19) United States
(12) Patent Application Publication
(10) Pub. No.: US 2008/0132397 A1
(43) Pub. Date: Jun. 5, 2008

(54) Centrifugal Separator For a Physiological Fluid, Particularly Blood

(76) Inventor: Jean-Denis Rochat, Genolier (CH)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/814,586

(22) PCT Filed: Jan. 23, 2006
(86) PCT No.: PCT/CH06/00048

§ 371 Date: Jul. 24, 2007

(30) Foreign Application Priority Data
Jan. 25, 2005 (EP) 05405037.2

(51) Int. Cl. B04B 7/12

(52) U.S. Cl. 494/45

(57) ABSTRACT

The invention relates to a centrifugal separator for a physiological fluid, particularly blood. The inventive separator comprises: a fixed conduit which continuously supplies a rigid disposable centrifugation chamber with the liquid to be separated; a fixed outlet conduit having an inlet port which is located in a concentrated area of at least one of the separated constituents having the lowest mass density in order for same to be removed continuously, said conduits being solidly connected to a fixed part of the chamber; means for guiding the chamber in rotation and means for driving the chamber around the axis of rotation defined by said guide means. The invention also comprises a second fixed outlet conduit having an inlet port which is located in a concentrated area of at least one of the separated constituents having the highest mass density in order for same to be removed continuously.

The present invention relates to a centrifugal separator for a physiological fluid, particularly blood, comprising a fixed conduit which continuously supplies a rigid disposable centrifugation chamber with the liquid to be separated, two fixed outlet conduits whose respective inlet ports are located in two zones of concentration of the separated constituents in order to remove them continuously, these fixed conduits being integrally connected to a fixed part of said chamber, means for guiding this chamber in rotation, means for driving, supporting and guiding in engagement with an axial coupling element integrally connected to the bottom of said chamber, and means for positioning the fixed part of said chamber relative to the means for driving, supporting and guiding.

Separators of this type that operate semi-continuously are already known in which the centrifugation chamber is formed by a disposable member. Consequently, among the aspects to be considered in assessing the advantages of a separator, two important factors, in addition to its separation performance, are the mean flow rate of the treated blood and the cost of the disposable part. As regards performance, the rate of hemolysis and activation is another important factor, which depends in particular on the forces applied to the constituents of the blood, in particular to the red blood cells and to the platelets, and on the duration for which these constituents are subjected to the forces that are intended to separate them from the other components of the blood. The more this duration is reduced, the more the rate of hemolysis diminishes. Thus, a relatively high force can be applied for a short duration, whereas a substantially smaller force causes a higher rate of hemolysis when it is applied for a substantially longer period. Consequently, the known centrifugation chambers have relatively large volumes, increasing the dwell time of the blood constituents in the centrifugation chamber and, therefore, the rate of hemolysis.

The cost of the disposable part is in particular related to its volume, and this directly determines the size of the separation installation and, therefore, its cost.

The forces exerted depend on the speed of rotation and the radius of the separation chamber.

In the vast majority of cases, the existing separators use centrifugation bowls or dishes of relatively large diameters, which are very often greater than the axial dimension of the bowl or dish.

Several centrifugal separators for plasmapheresis, operating semi-continuously, employ the principle disclosed in U.S. Pat. No. 4,300,717, in which the centrifugation bowl is formed by a bell, the blood flows during separation between a central core and the lateral wall of the bell, and the red blood cells are retained between the bell and the core, while the plasma is evacuated via an outlet located at the top of the bell. This same principle has been used, but without the central core, in EP 0,608,519.

In the abovementioned separators, the centrifugation bowls are not guided in a precise manner, with the result that the rotary seal must be designed not only to be able to ensure leaktightness, but also to compensate for the off-centering of the centrifugation chamber, which can be of several tenths of a mm about its axis of rotation. In the context of a system operating semi-continuously, in which the red blood cells are stored in the centrifugation bowl, this off-centering can be tolerated.

Among the separators operating continuously, most use a flexible tube to supply the blood to be separated and to remove its separated constituents. Mention may be made, in particular, of U.S. Pat. No. 5,750,025, U.S. Pat. No. 5,350,514 or U.S. Pat. No. 5,628,915. In two cases, the disposable separation chamber is formed by a flexible bag intended to be introduced onto a rigid rotary support. The placement of such a bag, equipped with a plurality of flexible conduits, onto this support constitutes a lengthy and awkward operation.

The system used to annul the effect of the rotation of the centrifugation chamber on the fixation of the flexible conduit to this chamber, in the centrifugal separators of this type, is disclosed in U.S. Pat. No. 3,586,413. By forming an open loop, of which one end is integral in rotation with the axis of the centrifugation dish turning at the speed 2w, whereas its other end, coaxial to the first end, is fixed while the open loop is driven at the speed w, it is possible to cause the flexible tube turning about its own axis to rotate at the speed −w and thereby annul any torsion of the flexible tube.

This principle, by which it is possible to omit any seal between the flexible tube and the rotating member, has been widely adopted in a large number of centrifugation devices operating with continuous flow. In contrast to the centrifuges with a fixed supply tube and removal tube, the separated components do not undergo a sudden deceleration of their tangential speed, with the result that the risks of hemolysis are reduced.

However, in view of the speed of the rotating member in a centrifuge, the flexible tube rotating on itself at the speed −w is subjected to a tensile stress generated by the centrifugal force, to a bending stress due to the portion of the tube that forms the open loop rotating on itself at the speed −w, and to heating generated by the work of the viscous forces in the material due to the abovementioned bending. In the case where blood is being centrifuged, its temperature must not exceed 40° C.

Consequently, the speed of rotation of the centrifugation dish is limited, which means that the diameter of this dish cannot be too small, in order not to impair the quality of the separation. In addition, the mechanism for driving the dish and the flexible tube is relatively complex and costly.

In JP 09 192215 and in EP 0 297 216, centrifugal separators have also been proposed that comprise a rigid conical centrifugation dish to which blood is supplied and separated components are removed via fixed conduits engaged in an upper axial opening of the dish. This dish is driven by friction and is guided by a drive disk equipped with an axial opening in which a cylindrical element projecting from the bottom of the dish is engaged. A sliding seal in the form of a bellows is arranged between the fixed conduits and the top of the conical dish. EP 0 297 216 does not include any guiding of the upper part of the dish, whereas in JP 09 192215 it is the edge of a protective cover of the sliding seal that bears on a conical surface of the top of the dish.

DE 198 22 191 has proposed guiding a centrifugation dish using three rollers which are integrally connected to a sliding ring and whose respective axes are parallel to a conical guide surface of the axis of rotation of the dish. The sliding ring is guided by a cylindrical surface parallel to the axis of rotation of the dish. The axial displacement of the guide rollers does not generally constitute an appropriate solution for the centrifugation chambers associated with fixed conduits passing through an axial opening at the upper end of these chambers. In addition, no provision is made for keeping the rollers integral with the sliding ring applied against the conical guide surface, with the result that the rotation of the chamber can cause an axial displacement of the sliding ring and does not therefore guarantee a correct guiding of the centrifugation chamber.

It can therefore be said that the existing solutions do not provide a satisfactory response to the need for a simple and compact separator that is easy to use, that works with inexpensive and disposable centrifugation chambers in which the blood to be treated has a minimum dwell time, and that is able to operate with a good flow rate.

It is for this reason that it appeared necessary to reconsider the design of the separator so as to be able to better respond to the abovementioned requirements.

The object of the present invention is to remedy, at least in part, the abovementioned disadvantages.

To this end, the present invention relates to a centrifugal separator according to claim 1.

The advantage of this centrifugal separator is that it operates in continuous flow with fixed conduits, which is admissible as long as the tangential force does not exceed a certain limit, so as not to subject the red blood cells and the platelets to too abrupt a deceleration when they pass from the centrifugation chamber into the fixed evacuation conduit.

As has been mentioned previously, the forces to which the red blood cells or the platelets are subjected do not constitute the only factor in hemolysis or activation. The duration for which these constituents of the blood are subjected to even moderate forces is another factor in hemolysis or activation.

This is the reason for which, preferably, the separator according to this invention permits precise guiding of the centrifugation chamber of the disposable type. A chamber of this type must be made of rigid plastic material. “Rigid” is to be understood as meaning a chamber that can be driven and guided directly by the driving and guiding means of the separator and that is able to withstand the centrifugal forces to which it is subjected. In order to achieve precise guiding of such a chamber, it must be as independent as possible of errors due to the inherent shrinkage of the plastic material and the tolerances of the mold. It is in fact known that all plastic material undergoes shrinkage while cooling, with the result that the more one operates with a large diameter, the more the error increases, the shrinkage being proportional to the dimension of the component.

Another factor is to be taken into consideration using fixed conduits for supply and continuous evacuation of the centrifugation chamber. It is necessary to use a chamber with a rubbing seal between the fixed supply and evacuation part and the rotating centrifugation part. It is thus advantageous to work with as small a diameter as possible in order to reduce heating. Precise guiding also makes it possible to reduce to a minimum the prestressing to which the seal has to be subjected, insofar as its sole function is to ensure leaktightness and no longer the errors due to imprecise guiding, as is the case of the known centrifugation chambers with fixed conduits for supply and evacuation.

The precise guiding of the centrifugation chamber in the centrifugal separator, in the case of separation with continuous flow, makes it possible to operate with a very small thickness of liquid on the wall of the centrifugation chamber and thus to reduce the dwell time of the liquid, thereby reducing the duration for which the constituents of the blood are subjected to the separation forces and therefore reducing the risks of hemolysis and activation of the platelets.

This guiding will be all the more precise if there is a large axial distance between the two axial guides of the centrifugation chamber. Consequently, it is also possible, preferably, to envisage reducing the diameter of the centrifugation chamber and making it rotate more quickly. This is made possible by virtue of the axial guiding of the chamber on the one hand via its base, which bears simply on the shaft of the drive motor and, on the other hand, via its upper guide surface of substantially smaller diameter than that of the centrifugation chamber, engaging with the guide rollers. This precise guiding and the use of small diameters makes it possible to reduce heating at the area of the rotating seal. The diameter of the centrifugation chamber can advantageously be small, since it is able to turn more quickly. Consequently, its volume, and thus its price, can substantially decrease, as can the dimensions and the volume of the centrifugal separator.

It will be evident from the above that the novel concept based on a centrifugation chamber with fixed conduits and on its precise guiding makes it possible to design a continuous-flow centrifugal separator which has a much smaller volume than the conventional separators of this type with flexible rotary conduits.

The attached drawing illustrates schematically, and by way of example, an embodiment of the separator according to the present invention.

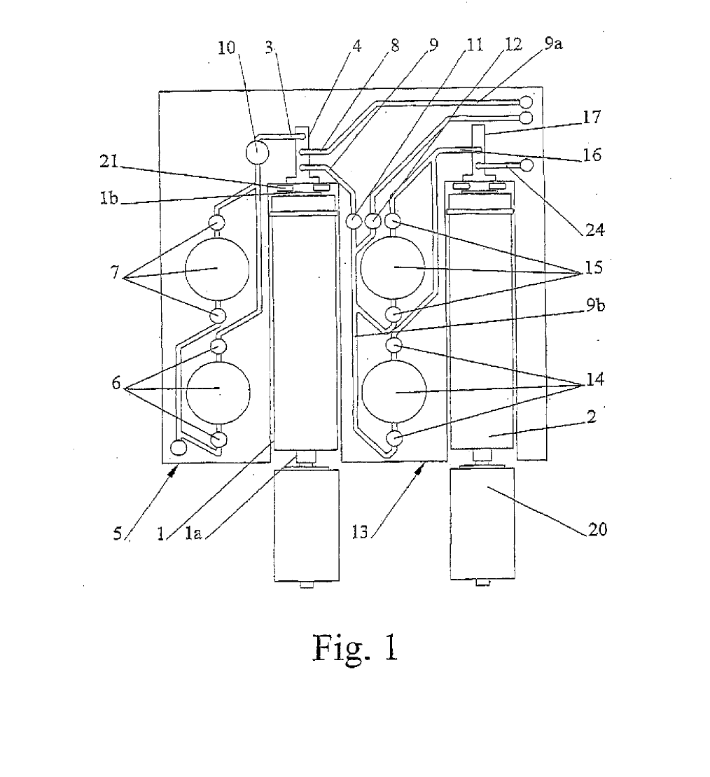

FIG. 1 is a front elevation of this embodiment;

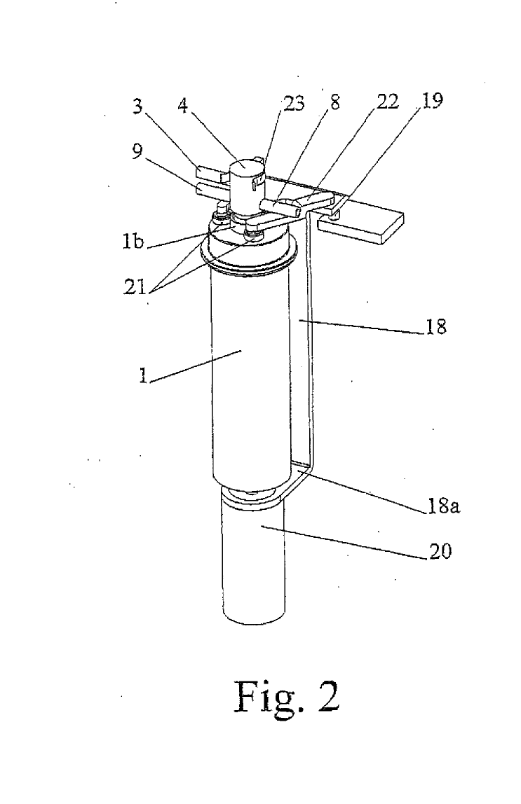

FIG. 2 is a partial perspective view of FIG. 1;

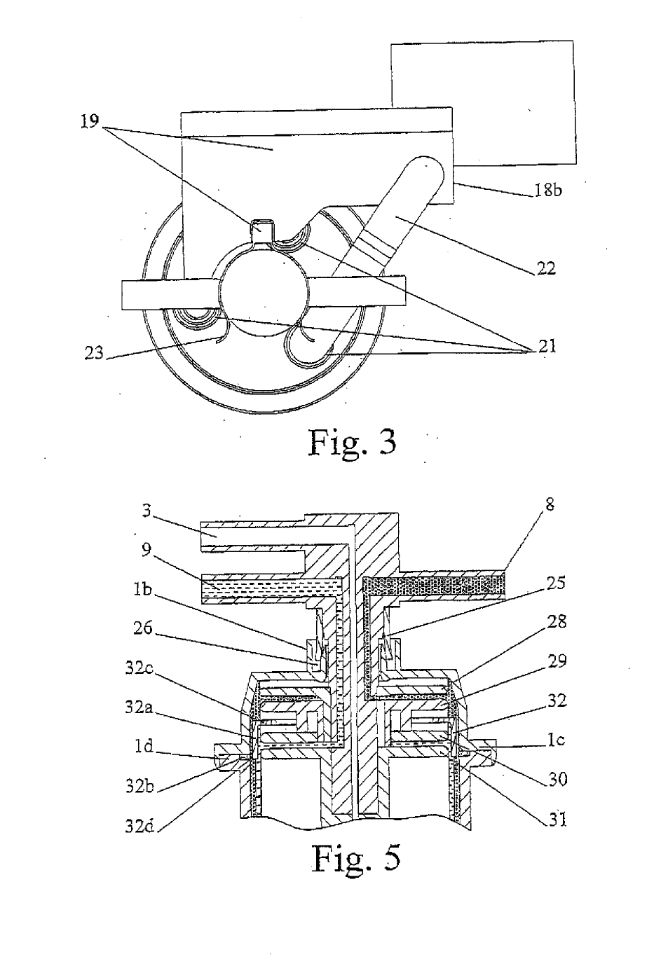

FIG. 3 is a plan view of FIG. 2;

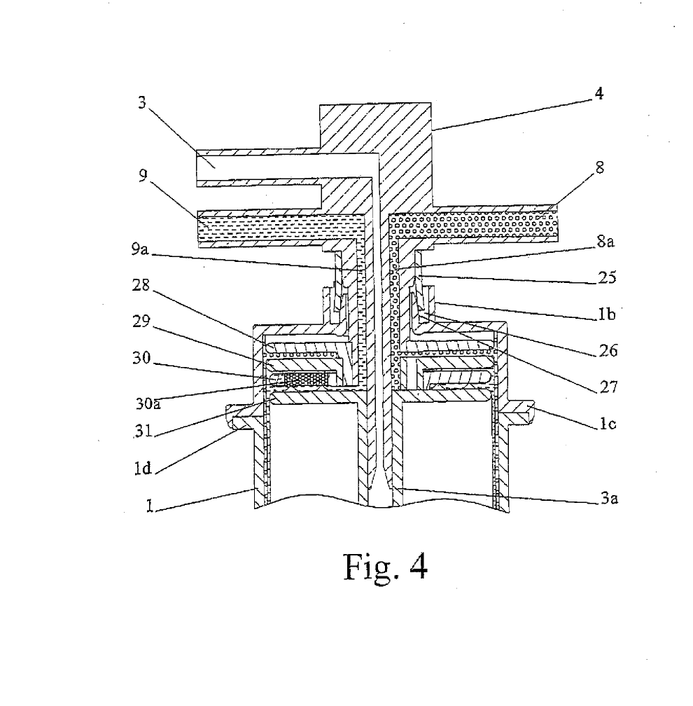

FIG. 4 is a partial view, in axial section, and on a larger scale, of the first embodiment of a centrifugation chamber;

FIG. 5 is a view, similar to FIG. 4, of a second embodiment of a centrifugation chamber.

The housing of the centrifugal separator intended to use the device according to the present invention is illustrated schematically by FIG. 1 and comprises two elongate centrifugation chambers 1, 2 of tubular shape. The first tubular centrifugation chamber 1 comprises a supply conduit 3, which is connected to a fixed axial inlet and outlet element 4 of the centrifugation chamber 1. This supply conduit 3 is connected to a pumping device 5, which comprises two pumps 6 and 7 phase-shifted by 180° relative to one another in order to ensure a continuous flow of a physiological liquid, particularly blood. An air detector 10 is arranged along the supply conduit 3.

Two outlet conduits 8, 9 are connected to the fixed axial element 4 in order to permit continuous withdrawal of two constituents of different densities of the physiological liquid. In the case of blood, the outlet conduit 8 is intended for the withdrawal of concentrated red blood cells RBC, and the conduit 9 is intended for the withdrawal of platelet rich plasma PRP. This outlet conduit 9 comprises a valve 11 and divides into two branches 9a, 9b. The branch 9a is used to recover the platelet concentrate and is controlled by a valve 12. The valves 11 and 12 function with exclusive OR logic, either to pass the PRP from the chamber 1 to the chamber 2, or to empty the platelet concentrate from the chamber 2 to the outlet 9a. The branch 9b is used to convey the PRP to a pumping device 13 that comprises two pumps 14 and 15 phase-shifted by 180° and serving to ensure continuous supply of the second tubular centrifugation chamber 2 via a supply conduit 16 connected to a fixed axial element 17 of the second tubular centrifugation chamber 2. An outlet conduit 24 for the platelet poor plasma PPP is also connected to the fixed axial element 17.

FIG. 2 shows the way in which the tubular centrifugation chamber 1 is driven and guided. All the elements for driving and guiding the tubular centrifugation chamber are located on a common support 18 connected to the housing of the centrifugal separator via an anti-vibration suspension 19 of the silent block type. The support 18 has a vertical wall, the lower end of which is terminated by a horizontal support arm 18a, to which a drive motor 20 is fixed. The drive shaft 20a of this motor 20 has a polygonal shape, such as a Torx® profile, complementing an axial recess formed in a small tubular element 1a that projects from under the bottom of the tubular centrifugation chamber 1. The coupling between the drive shaft of the motor 20 and the tubular element 1a must be effected with very great precision, in order to ensure extremely precise guiding of this end of the tubular centrifugation chamber 1.

The upper end of the tubular centrifugation chamber 1 comprises a cylindrical element 1b for axial guiding, which has a diameter substantially smaller than that of the tubular centrifugation chamber 1 and which protrudes from the upper face of the latter. The cylindrical face of this element 1b is intended to engage with three centering rollers 21, which can be seen in particular in FIG. 3. One of these rollers 21 is integrally connected to an arm 22, of which one end is mounted pivotably on an upper horizontal part 18b of the support 18. This arm 22 is subjected to the force of a spring (not shown) or any other suitable means intended to impart to it a torque that tends to turn it in the clockwise direction if referring to FIG. 3, such that it bears elastically against the cylindrical surface of the cylindrical element 1b for axial guiding, with the result that the tubular centrifugation chamber can be put into place and removed from the support 18 by pivoting the arm 22 in the counter-clockwise direction. A device for locking the angular position of the arm 22 corresponding to that in which its roller 21 bears against the cylindrical surface of the cylindrical element 1b for axial guiding is provided, in order to avoid having excessive prestressing of the spring associated with the arm 22.

The span between the cylindrical element 1b for axial guiding and the upper end of the tubular chamber 1 serves, in cooperation with the centering rollers 21, as an axial abutment preventing decoupling between the drive shaft of the motor 20 and the axial recess of the tubular element 1a which protrudes from under the bottom of the tubular chamber 1.

Advantageously, the axes of rotation of the guide rollers 21 could also be inclined slightly by a few angle degrees, <2°, in respective planes tangential to a circle coaxial to the axis of rotation of the tubular centrifugation chamber 1, passing through the respective axes of rotation of the three rollers, in a direction chosen as a function of the direction of rotation of the rollers, in which these induce, on the tubular chamber 1, a force that is directed downward.

An elastic element 23 for centering and fixing of the fixed axial inlet and outlet element 4 of the tubular centrifugation chamber is integrally connected to the upper horizontal part 18b of the support 18. This element 23 comprises two symmetrical elastic branches, of semi-circular shape, which each end in an outwardly curved part that is intended to transmit, to these elastic branches, forces allowing them to move away from one another during lateral introduction of the axial fixed inlet and outlet element 4 between them.

As will be seen, all the elements for positioning and guiding the fixed and rotating parts of the tubular centrifugation chamber 1 are integrally connected to the support 18, such that the precision is a function of the precision of the support 18 itself, which can be manufactured with very tight tolerances, especially as it is not a component that is complicated to produce. The other factors that help guarantee a high level of precision are the relatively large axial distance, due to the elongate shape of the centrifugation chamber, between the lower guiding means and the upper guiding means. Finally, the fact of working on a cylindrical guide surface 1b of small diameter makes it possible to reduce, on the one hand, the errors due to shrinkage of the injected plastic material from which the centrifugation chambers 1, 2 are produced, the shrinkage being proportional to the dimension, in contrast to the case of a machined component and, on the other hand, out-of-round errors.

This precision with which the tubular centrifugation chamber is guided makes it possible to form very thin flows on the lateral wall of this centrifugation chamber. This makes it possible to have a small volume of liquid residing in the chamber, which is a factor able to reduce the risk of hemolysis and the risk of platelet activation, this risk admittedly being dependent on the forces applied, but also being dependent on the length of time for which the components of the blood are subjected to these forces. Thus, it is not possible to set a force threshold, since, for a given force, the risk of hemolysis may be practically zero for a certain period of time, whereas it may be much greater, with the same force, but over a substantially longer period of time.

The tubular centrifugation chambers will preferably have a diameter of between 10 and 40 mm, preferably of 22 mm, and will be driven at a speed of rotation of between 5000 and 100,000 rpm, such that the tangential speed to which the liquid is subjected does not exceed 26 m/s. The axial length of the tubular centrifugation chamber is advantageously between 40 and 200 mm, preferably 80 mm. Such parameters ensure a liquid flow rate of between 20 and 400 ml/min (particularly for dialysis), preferably 60 ml/min, which corresponds to a dwell time of the liquid, within the tubular chamber, of 5 to 60 s, preferably 15 s.

We will now examine in greater detail the design of the tubular centrifugation chamber 1 intended to be associated with the centrifugal separator that has just been described. It may be noted here that everything that has been explained in the preceding description with regard to the dimensions, drive, positioning and guiding of the tubular centrifugation chamber 1 also applies to the tubular centrifugation chamber 2. By contrast, since the latter has only an outlet 24 for the PPP, its internal design is simpler than the tubular chamber 1.

As is illustrated in FIG. 4, the tubular chamber 1 is made up of two parts that end in respective annular flanges 1c, 1d welded to one another. The interior space of the chamber is delimited by the essentially cylindrical wall of this chamber. The fixed axial inlet and outlet element 4 penetrates into this tubular chamber 1 through an axial opening formed through the cylindrical element 1b for axial guiding. The sealing between this axial opening, integrally connected to the rotationally driven chamber and the fixed axial element 4, is achieved by a tubular seal 25, one segment of which is fixed to a cylindrical portion of this fixed axial inlet and outlet element 4, while another segment is introduced into an annular space 26 of the cylindrical element 1b for axial guiding and bears on a convex surface of the tubular wall 27 separating the axial opening, through the cylindrical element 1b for axial guiding, from the annular space 26. This seal keeps the liquid contained in the centrifugation chamber sterile. As is illustrated in FIG. 4, that part of the tubular seal 25 that bears on the tubular wall 27 undergoes a slight radial deformation in order to ensure leaktightness.

It can be seen that the diameter against which the tubular seal 25 rubs is small and preferably <10 mm, such that heating is limited to acceptable values. From the possible dimensions given hereinabove for the tubular centrifugation chamber, it can be seen that the axial distance between the upper and lower centering and guiding means of this chamber is greater than five times the diameter of the cylindrical element 1b for axial guiding. Giver, the precision with which the tubular chamber 1 is guided and the precision that the relative positioning of the fixed axial inlet and outlet element 4 can achieve, the seal has practically no need to compensate for eccentricity of the rotating tubular chamber 1, as it does in the above-mentioned prior art devices that operate with semi-continuous flow. This also helps reduce the heating of the rotating tubular seal 25 and thus makes it possible to increase the speed of rotation of the tubular centrifugation chamber.

The fixed axial inlet and outlet element 4 comprises a tubular part 3a by which the supply conduit 3 connected to this fixed axial element 4 is continued to a point close to the bottom of the tubular centrifugation chamber 1, to where it can convey the blood or another physiological liquid that is to be separated.

The outlet conduits 8 and 9 connected to the fixed axial inlet and outlet element 4 each comprise an axial segment 8a and 9a respectively, which penetrates into the tubular chamber and opens out into that part of the fixed axial inlet and outlet element 4 that is located near the upper end of the tubular centrifugation chamber 1. The inlet end of each of these outlet conduits 8a, 9a is formed by a circular slit. Each of these slits is formed between two disks 28, 29 and 30, 31 respectively, which are integrally connected to the fixed axial inlet and outlet element 4.

In this example, the radial distance between the edges of the disks 28, 29 and the lateral wall of the chamber 1 is less than the radial distance between the edges of the disks 30, 31 and this same lateral wall. By means of this arrangement, the platelet rich plasma PRP, having a lower density than the red blood cells RBC, is aspirated by the pumping device 13 (FIG. 1) into the outlet conduit 9, whereas the red blood cells are aspirated into the outlet conduit 8 by the pressure gradient generated by the centrifugal force within the liquid.

As can be seen, the diameter of that part of the tubular centrifugation chamber 1 that is located in the PRP and RBC outlet zone where the disks 28 to 31 are located is slightly larger than that of the rest of this tubular chamber 1, such as to increase the respective thicknesses of the layers of PRP and RBC in order to make them easier to extract separately.

A dead space is formed between the adjacent disks 29 and 30. Its role is to trap the leukocytes, the density of which is between that of the RBC and of the platelets, but which are very much larger than the REC and the platelets. The disk 30 comprises a filter 30a to separate the leukocytes from the plasma and to trap only the leukocytes in the dead space between the disks 29 and 30.

The second embodiment of the tubular centrifugation chamber, illustrated in FIG. 5, differs from that of FIG. 4 principally in terms of the presence of a barrier 32. The latter has an annular shape comprising a cylindrical part 32a situated opposite the circular inlet opening for PRP formed between the disks 30 and 31. The diameter of this cylindrical part 32a is chosen such that it can fit in the space separating the edges of the disks 28, 29 from the lateral wall of the chamber 1 corresponding substantially to the interface between the layers formed by the RBC and the PRP The two ends of this cylindrical part 32a end in flat rings 32b, 32c. The flat ring 32b extends outside the cylindrical part 32a, while the flat ring 32c extends inside this cylindrical part 32a. The outer flat ring 32b is housed in a recess in the annular flange 1d and is gripped between the two annular flanges to and 1d. This outer flat ring 32b also has a plurality of openings 32d extending through it for the passage of the RBC.

This barrier 32 has three roles to play. One is to create a physical barrier between the circular PRP inlet opening, situated between the disks 30 and 31, and the RBC, in such a way as to ensure that the disturbances caused by the aspiration at the inlet opening do not risk causing the RBC and the PRP to mix together again. A second role is to allow the RBC to be collected on the same diameter as the plasma, which reduces hemolysis, because the edges of the disks 30, 31 that form the outlet opening for the RBC are less immersed in the layer of RBC, since all the disks 2B to 31 are of the same diameter. Finally, the third role is to at least partially retain the leukocytes inside the cylindrical part 32a of the barrier 32.

The rest of this tubular centrifugation chamber 1 according to this second embodiment is practically similar to the first embodiment that has just been described. A leukocyte removal filter similar to the filter 29a in FIG. 4 can also be provided in order to trap the leukocytes between the disks 29 and 30.

1. A centrifugal separator for a physiological fluid, particularly blood, comprising a fixed conduit which continuously supplies a rigid disposable centrifugation chamber with the liquid to be separated, two fixed outlet conduits whose respective inlet ports are located in two zones of concentration of the separated constituents in order to remove them continuously, these fixed conduits being integrally connected to a fixed part of said chamber, means for guiding this chamber in rotation, means for driving, supporting and guiding in engagement with an axial coupling element integrally connected to the bottom of said chamber, and means for positioning the fixed part of said chamber relative to said means for driving, supporting and guiding, wherein it further comprises rotary guide means for engaging with a cylindrical surface that is coaxial with respect to said axis of rotation and integrally connected to the upper end of said chamber.

2. The separator as claimed in claim 1, in which said centrifugation chamber is tubular and has a diameter of between 10 and 80 mm, and the speed at which it is driven is between 3000 and 100,000 rpm, such that the tangential speed applied to said constituents is less than 26 m/s.

3. The centrifugal separator as claimed in claim 1, comprising, on the one hand, a drive shaft, for supporting and guiding, which is coaxial with respect to the axis of rotation of said chamber and is designed to engage with an axial coupling element integrally connected to the bottom of said chamber and, on the other hand, at least three rotary guide rollers distributed about said axis of rotation and at equal distances from the latter, for engaging with a cylindrical surface % integrally connected to the upper end of said chamber, one of said rotary guide rollers being mounted in such a way as to be able to be moved away from said axis of rotation in order to permit the introduction and removal of said chamber.

4. The separator as claimed in claim 3, in which said cylindrical surface with which the rotary guide rollers engage has a diameter substantially smaller than that of the centrifugation chamber.

5. The separator as claimed in claim 1, in which the side of said rotary guide means for engaging with a surface of revolution coaxial with respect to said axis of rotation and integral with the upper end of said chamber directed toward the bottom of said chamber is adjacent to a surface area of said chamber for limiting the freedom of axial displacement thereof.

6. The separator as claimed in claim 3, in which the pivot axis of at least one of said guide cylinders has an inclination of <2° in a plane tangential to a circle centered on the axis of rotation of said chamber.

7. The separator as claimed in claim 1, in which the axial distance between the driving and guiding end of said drive shaft and said guide cylinders is at least equal to 5 times the distance separating the guide cylinders from the axis of rotation of said centrifugation chamber.

8. The separator as claimed in claim 1, in which said means for driving, supporting and guiding and said rotary guide means are integrally connected to a common support linked to the framework of the separator via an anti-vibration suspension.
